(19) United States
(12) Patent Application Publication
(10) Pub. No.: US 2001/0007723 A1
(43) Pub. Date: Jul. 12, 2001

(54) Glass substrate for magnetic recording medium, manufacturing method thereof, and magnetic recording medium incorporating the glass substrate

(76) Inventor: Takahiro Tokumoto, Nagano (JP)

Correspondence Address: Thomas R. Morrison, Esq., MORRISON LAW FIRM, 145 North Fifth Avenue, Mount Vernon, NY, 10550, US

(21) Appl. No.: 09/746,442

(22) Filed: Dec. 20, 2000

(30) Foreign Application Priority Data
Dec. 24, 1999 (JP) 11-368038

(51) Int. Cl. G11B 5/82

(52) U.S. Cl. 428/694 ST

(57) ABSTRACT

A surface of a glass substrate is strengthened relative to a non-tempered bulk by heating the substrate to a temperature near its softening temperature, and then rapidly cooling the glass substrate. This process forms a compressive-stressed layer at the surface over the non-tempered bulk. The manufacture of a magnetic recording medium using the strengthened substrate is also disclosed.

### BACKGROUND

1. Field of the Invention

The present invention relates to a glass substrate for a magnetic recording medium and a manufacturing method thereof, and a magnetic recording medium incorporating the glass substrate.

2. Related Art

Magnetic disk recording apparatus of large capacity have been developed recently. The large capacity of the apparatus requires a high recording density. This, in turn, require a decreased flying height of a magnetic head. Decreasing the flying height of a magnetic head requires a magnetic recording medium of excellent surface smoothness. A magnetic layer on a substrate in a conventional magnetic recording medium, has thickness of about 0.5 μm or less. Since the magnetic layer is so extremely thin, the roughness of the surface the substrate upon which it is coated is the major contributor to surface roughness of the magnetic layer. The substrate of a magnetic recording medium, therefore, requires excellent surface smoothness.

Polishing smooths the surface of glass with relative ease. Thus a glass substrate meets the demand for a substrate of a magnetic recording medium. The development of a glass substrate has been under way for some time.

As stated earlier, glass has an advantage of being easily smoothed. However, glass is brittle, and requires strengthening by surface treatment. The surface of a glass substrate may be strengthened, for instance, by an ion-exchange method as is disclosed in Japanese Laid-Open Patent Publication No.11-328601. The ion-exchange method replaces one metal ion in the glass substrate with another metal ion whose ionic radius is larger. The presence of a surface layer of metal ions having a larger ionic radius than the metal ions in the interior of the substrate produces a compressive-stressed surface layer which increases the strength of the glass substrate. For example, in a glass substrate having predominantly Li⁺ions, the Li⁺ions in a surface layer may be replaced with Na⁺ions which have a larger ionic radius. Similarly, in a glass substrate having predominantly Na⁺ions, the Na⁺ions in a surface layer may be replaced with K⁺ions, which have a larger ionic radius than the Na⁺ions.

The ion-exchange method is generally known as chemical strengthening. The ion-exchange method is performed by soaking the glass substrate in a molten salt at a temperature of about 400° C. for about 1 to 5 hours to exchange ions in the first few micrometers below the glass surface with the ions in the molten salt.

Chemical strengthening of a glass substrate as described above requires a relatively long time. Hence, chemical strengthening raises the problem that producing a glass substrate by chemical strengthening takes too long a time to meet the demand. This long time damages productivity and increases cost which must be added to audio and visual equipment, etc.

Decreasing the time for the ion exchange in chemical strengthening provides one solution. However, decreasing the time reduces the amount of strengthening of the substrate. Thus, the development of a new process for substrate strengthening is required.

### OBJECTS AND SUMMARY OF THE INVENTION

One object of the present invention is to offer a glass substrate for a magnetic recording medium that is physically strengthened at its surface.

Another object of the present invention is to offer a manufacturing process for a glass substrate enabling the reduction in time and overall cost of production.

A further object of the present invention is to offer a magnetic recording medium incorporating a glass substrate processed by the present invention which is physically strengthened at its surface.

Means for Solving the Problem

The following describes the details of the present invention to solve the problem mentioned earlier.

A first embodiment of the invention concerns a glass substrate for a magnetic recording medium comprising a compressive-stressed layer and a non-tempered bulk. The compressive-stressed layer is formed on the non-tempered bulk. The compressive-stressed layer is formed by heating, and rapidly cooling a glass substratum.

A second embodiment of the invention concerns a manufacturing method of a glass substrate for a magnetic recording medium comprising the steps of heating a glass substratum and rapidly cooling the glass substratum.

In the second embodiment the glass substratum is cooled rapidly by blowing nitrogen gas against the glass substratum.

The surface of the glass substratum can also be cooled rapidly by immersing the glass substratum in a liquid such as an organic solvent and water. Spraying the liquid on the glass substratum can also be used to cool the glass substratum.

A third embodiment of the invention concerns a magnetic recording medium using a glass substrate stated earlier. The magnetic recording medium comprises a glass substrate, a magnetic layer, a protective layer and a liquid lubricating layer. The magnetic layer, protective layer, and liquid lubricating layer are formed one on top of another on the glass substrate. The glass substrate includes a compressive-stressed layer layered on a non-tempered bulk.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a cross section of a glass substrate according to an embodiment of the invention.

FIG. 2 is a cross section of a recording medium using the glass substrate of FIG. 1.

### DETAILED DESCRIPTION OF THE PREFERRED EMBODIMENTS

A first embodiment of the invention concerns a glass substrate for a magnetic recording medium strengthened physically at the surface.

A glass substrate of the present invention is characterized by a glass substrate whose surface is physically strengthened. Physical strengthening in the present invention means tempering the glass at the surface of the substrate. Heating a glass substratum to a pre-determined temperature, and then quickly cooling the surface of the glass substratum tempers the glass surface in a very short time. Processing the surface of the glass substratum in this way forms a compressive-stressed layer (a distorted layer) at the surface of the glass substratum which strengths the glass substrate. Heating the surface of a glass substratum preferably to around its softening temperature, and then thoroughly cooling the surface of the glass substratum, generates a temperature difference between an outer layer and an inner bulk of the glass substrate. This temperature difference develops thermal stress at an interface plane between the outer layer and the inner bulk of the glass substrate. This thermal stress provides a compressive-stressed layer at the surface of the glass substrate.

The glass substratum is heated thoroughly. The heating temperature is subject to the particular glass substratum used, and thus cannot be specified in general. However, one skilled in the art will recognize that the glass substratum is usually heated at temperatures of about 300 to 600° C., and preferably to around the softening temperature of the glass substratum.

Any technique for rapid surface cooling a heated glass substratum satisfies the requirement for a rapid cooling process. Processes referred to in a second embodiment of the invention stated hereinafter, among others, can be enumerated as examples of a rapid cooling process.

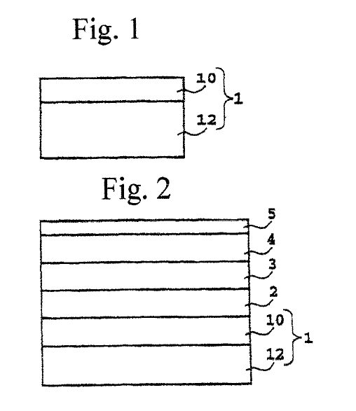

Referring to FIG. 1, a glass substrate 1 of the present invention consists of a compressive-stressed layer (a distorted layer) 10 at the surface of a non-tempered bulk 12. The compressive-stressed layer (a distorted layer) 10, which is a tempered layer, is unified with a non-tempered bulk 12 to produce the glass substrate 1. The thickness of the compressive-stressed layer 10 is around one sixth of the total thickness of the glass substrate 1. For instance, a medium with a width of about 2.5 inches may have a glass substrate 1 with a thickness of around 0.6 to 0.7 mm. Hence, the thickness of the compressive-stressed layer 10 amounts to around 50 to 200 μm.

The glass substratum of the present invention places no particular restrictions on plate-glass materials, so long as the glass substratum is tempered by the heating and rapid cooling process mentioned earlier. Glass containing metal oxides is preferred. Glass containing metal oxides includes soda lime glass, borosilicate glass, aluminosilicate glass, aluminoborosilicate glass, and aluminum-aluminosilicate glass.

A second invention concerns a method for manufacturing a physically strengthened glass substrate referred to earlier in the first embodiment mentioned.

This method includes a first and a second process. The first process heats a glass substratum. The second process cools the surface of the heated glass substratum rapidly.

In the first process, the glass substratum is heated to a pre-determined temperature for physical strengthening. The precise heating temperature depends on the particular glass used, and is not specified. The heating temperature is in the range of about 300 to 600° C., and is preferably around the softening temperature of the glass substratum. The heating period also depends on the glass substratum used, and is not specified. The glass substratum is heated for a duration that establishes the thickness of a compressive-stressed layer mentioned earlier to around one sixth of the thickness of the glass substratum.

The glass used in a second embodiment is similar to the glass referred to in a first embodiment. Previously chamfering, lapping, and polishing the surface of the glass substratum, etc is recommended.

The glass substratum may be heated with a suitable heating device with no particular restrictions thereon.

In a second process, a glass substratum, heated in a first process, is cooled rapidly. Cooling or cooling rapidly in the present invention refers to rapidly cooling the glass substratum surface to form the compressive-stressed layer (a distorted layer) 10 at the surface of the heated glass substratum.

The particular glass substratum puts no restrictions on the cooling process. The glass substratum is cooled, for instance, with a gas, including nitrogen, blown over its surface, or with a liquid such as an organic liquid or water. The liquid may be sprayed on the surface, or the glass substratum may be immersed in the liquid. No restrictions are placed on the cooling liquid so long as it enables the efficient cooling of the glass substratum. Suitable cooling liquids include a solution of a high boiling point organic compound such as methylpolysiloxane, and water. It is preferred that a gas or a liquid used for cooling has no impurities to prevent pollution of the glass substratum.

No particular limitation is placed on cooling conditions if the cooling conditions provide the desired glass substrate strength. For instance, a glass substratum may be cooled with nitrogen gas blown over at pressures of 2 to 5 kgf/cm² depending on the glass substratum used. In the preferred embodiment, a pressure of about 4 kgf/cm² is used. Further, the glass substratum may be cooled, for instance, with a solution of a high boiling point organic compound kept at around room temperature either applied to the surface by spraying, by immersion of the substratum in the organic compound.

Processing a glass substratum in these ways provides a glass substrate 1 of the present invention having a tempered glass surface (a compressive-stressed layer 10) as shown in FIG. 1.

The compressive-stressed layer 10 of the present invention strengthens physically the surface of the glass substrate 1, whence the compressive-stressed layer 10 is integrated with the non-tempered bulk 12 of the glass substrate 1.

A third embodiment of the invention concerns a magnetic recording medium incorporating the glass substrate of the first embodiment mentioned earlier.

Referring to FIG. 2, a magnetic recording medium 100 of the present invention begins with a glass substrate 1, described earlier. A non-magnetic under layer 2 is deposited on the surface of the glass substrate 1. A magnetic layer 3 is deposited on the non-magnetic under-layer 2. A protective layer 4 is deposited on the magnetic layer 3. Finally, a liquid lubricating layer 5 is deposited on the surface of the protective layer 4.

Since the glass substrate 1 of the present invention has the compressive-stressed layer 10 integrated with its surface, the need for covering the surface of the glass substrate with a non-magnetic metal layer, etc. is eliminated. Conventional materials are suitable for the non-magnetic under layer 2, magnetic layer 3, protective layer 4, and liquid lubricating layer 5 mentioned above.

To be concrete, the non-magnetic under layer 2 may be, for instance, chromium. Magnetic layer 3 may be a suitable cobalt alloy including cobalt-chromium-tantalum ferromagnetic alloy and cobalt-chromium-platinum ferromagnetic alloy. Protective layer 4 may be, for instance, carbon. Further, the liquid lubricating layer 5 may be, for example, a perfluoropolyether lubricant.

The magnetic recording medium 100 may be varied in structure in accordance with the purpose of the magnetic recording medium. Magnetic recording medium 100 may have different shapes according to the requirements of the apparatus incorporating the magnetic recording medium 100. No particular restrictions are put on the form of a magnetic recording medium. A circular shape for the magnetic recording medium 100, for instance, is suitable for use in a hard disk drive.

The following describes the manufacturing process of a magnetic recording medium of the present invention. Compressive-stressed layer 10 is formed at the surface of a glass substrate 1 according to the second embodiment of manufacturing a glass substrate 1 mentioned earlier. Glass materials referred to in a first embodiment stated earlier may be applied to the glass substrate 1.

The surface of the compressive-stressed layer 10 may be smoothed, if necessary, before continuing. Compressive-stressed layer 10 of the substrate 1 is coated with non-magnetic under layer 2. The magnetic layer 3 and the protective layer 4 are formed on the compressive-stressed layer 10. Then, the liquid lubricating layer 5, consisting of a lubricant diluted with a solvent, is formed on the protective layer 4.

It is preferred in the present invention that the non-magnetic under layer 2 is made of chromium, and the magnetic layer 3 is made of a cobalt alloy.

Non-magnetic under layer 2, magnetic layer 3, and protective layer 4, made, for instance, of chromium, a cobalt alloy, and carbon respectively, may be formed using DC sputtering. Carbon protective layer 4 may be composed of carbon with conventional graphite as its main ingredient. Alternatively, protective layer 4 may be composed of a diamond-like carbon. The liquid lubricating layer 5 may be applied using, for example, dip coating or spin coating. Each of the layers, non-magnetic under layer 2, magnetic layer 3, protective layer 4, and lubricating layer 5, have thicknesses suitable for use in a conventional magnetic recording medium. However, the present invention is not limited to a particular use, layer thickness or material.

### EXAMPLES

The following describes examples and a comparative example of the present invention.

### Example 1

The surface of a circular glass substratum was filleted, lapped, and polished. The glass substratum had a diameter of 64 mm, a thickness of 0.65 mm, and was made of aluminosilicate-aluminum glass. The circular glass substratum was heated in an electric furnace to around its softening temperature of 500 to 600° C. After a suitable time, the heated glass substratum was taken out of the electric furnace. Clean nitrogen gas, at a pressure of 4 kgf/cm², was blown against the surface of the glass substratum with a fan. The nitrogen gas rapidly cooled the surface of the glass substratum, thereby forming a compressive-stressed layer at the surface.

Transverse strength and Vickers microhardness Hv of the glass substrate were measured by the following method to evaluate the hardness of the substrate. The time required for the tempering process was also measured.

1. Annulus Ring Test

A glass substrate was mounted on an annulus ring stand of almost the same outer diameter. A circle of almost the same outer diameter as the inner diameter of the annulus ring stand was put on the glass substrate. The circle was pressed with a load of 51 newton at a velocity of 0.5 mm/min. The force causing a transverse break of the glass substrate was measured.

2. Vickers Microhardness

A glass substrate was pressed with a four-sided pyramid indentater with a force of 50 g at a load rate of 0.24 mN/s to measure Vickers microhardness.

3. Process Time

The time required to perform the tempering process was measured.

### Example 2

A glass substrate was manufactured in the same way as in example 1 except that the substratum was heated to about its softening temperature and then was cooled rapidly by immersing it in the organic compound liquid methyl polysiloxane solution maintained at a temperature of 15° C. The transverse strength, Vickers microhardness, and process time of the glass substrate was measured.

### Example 3

A glass substrate was manufactured in the same way as that in example 1 except that a heated substratum in example 2 was cooled rapidly by immersion in ultrapure water at room temperature. The transverse strength, Vickers microhardness, and process time of the glass substrate were measured.

### Comparative Example 1

A circular glass substratum was filleted, lapped, and polished prior to the remaining operations. The glass substratum had a diameter of 64 mm, a thickness of 0.65 mm, and was made of aluminosilicate-aluminum glass. The circular glass substratum was immersed in fused potassium nitrate kept at 400° C. for 4 hours to exchange sodium ions Na⁺of the glass substratum with potassium ions K⁺. Next, the glass substratum was immersed and cooled in ultrapure water for about ten minutes in a conventional way. The transverse strength, Vickers microhardness, and process time of the glass substrate was measured in the same way as those in example 1.

Evaluation of Substrate

Glass substrates for magnetic recording media referred to in examples 1, 2, 3 and comparative example 1 were evaluated in terms of transverse strength, Vickers microhardness, and process time referred to in example 1. Table 1 lists the results of the evaluation.

TABLE 1

| | | | | Process time |
|---|---|---|---|---|
| | | Transverse | Vickers | per substrate |
| | | strength | microhardness | (min.) |
| Example | 1 | 132 | 580 | 2 |
| Example | 2 | 173 | 590 | 1.5 |
| Example | 3 | 163 | 550 | 2 |
| Comparative | 1 | 204 | 610 | 2.5 |
| Example | | | | |

Evaluation of the data demonstrates that the substrates referred to in example 2 and 3 have the same strength as that referred to in comparative example 1. Moreover, the process time of the substrate referred to in example 2 and 3 are shortened to 60% of that referred to in comparative example 1. Besides, the evaluation of the process time of the substrate referred to in example 1 shows a comparatively excellent result. Thus, shortening the overall process time of a glass substrate reduces the manufacturing cost of the glass substrate, and thus reduces the manufacturing cost of the magnetic recording medium. Further, eliminating the need for a particular solvent in manufacturing a glass substrate referred to in example 3 brings a particularly large reduction in manufacturing cost of a glass substrate, compared with necessary molten salt in the ion exchange technique of chemical strengthening.

Effect of the Invention

As described above, physically strengthening a glass substrate provides a glass substrate suitable for a magnetic recording medium of the present invention. Physically strengthening the glass substrate provides a glass substrate with the same strength as that manufactured by chemical strengthening via an ion exchange technique, but with a large decrease in a process time and material cost. Hence, the present invention provides a glass substrate with a low manufacturing cost and high performance.

In addition, the glass substrate of the present invention provides a magnetic recording medium with excellent durability, made at low manufacturing cost.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

For example, in the technique described in Example 1, cooling by spraying with ultrapure water, or submersion in ultrapure water, may be substituted for the cooling with a flow of nitrogen gas.

Spraying with a suitable liquid organic compound, may be substituted for immersion in a liquid organic compound as recited in Example 2. Other suitable liquid organic compounds than methylpolysiloxane solution may be substituted for either immersion or spraying without departing from the spirit and scope of the invention.

Spraying with ultrapure water may be substituted for submersion in ultrapure water in example 3.

### DESCRIPTION OF REFERENCE NUMERALS

1 substrate

2 non-magnetic under layer

3 magnetic layer

4 protective layer

5 liquid lubricating layer

10 compressive-stressed layer (distorted layer)

12 non-tempered bulk

What is claimed is:

1. A glass substrate for a magnetic recording medium comprising:
a non-tempered bulk; and
a compressive-stressed layer on said non-tempered bulk.

2. A glass substrate for a magnetic recording medium according to claim 1, wherein said compressive-stressed layer is formed by heating, and rapidly cooling a glass substratum.

3. A method for manufacturing a glass substrate for a magnetic recording medium comprising the steps of:
heating a glass substratum; and
cooling rapidly a surface of said glass substratum to form a compressive-stressed layer thereon.

4. A method for manufacturing a glass substrate for a magnetic recording medium according to claim 3, wherein the step of cooling includes blowing a nitrogen gas over said surface.

5. A method for manufacturing a glass substrate for a magnetic recording medium according to claim 3, wherein the step of cooling includes immersing said glass substratum in an organic solvent.

6. A method for manufacturing a glass substrate for a magnetic recording medium according to claim 3, wherein the step of cooling includes immersing said glass substratum in pure water.

7. A method for manufacturing a glass substrate for a magnetic recording medium according to claim 5, wherein the step of cooling includes spraying a surface of said glass substratum with an organic solvent.

8. A method for manufacturing a glass substrate for a magnetic recording medium according to claim 3, wherein the step of cooling includes spraying said glass substratum with pure water.

9. A magnetic recording medium comprising:
a glass substrate;
said glass substrate having a compressive-stressed layer on a non-tempered bulk;
a magnetic layer on said compressive-stressed layer;
a protective layer on said magnetic layer; and
a liquid lubricating layer on said protective layer.

10. A magnetic recording medium according to claim 9 further comprising a non-magnetic under-layer between said compressive-stressed layer and said magnetic layer.

11. A method for strengthening a glass substrate comprising:
heating said glass substrate to a temperature for a time;
cooling a surface of said glass substrate at a rate rapid enough to produce a compressive-stressed surface layer on a non-tempered bulk; and
said time being sufficient to control a thickness of said compressive-stressed surface layer to a desired value.

12. A method according to claim 11, wherein said temperature is near a softening temperature of said glass substrate.
